(19) United States
(12) Patent Application Publication
(10) Pub. No.: US 2007/0177383 A1
(43) Pub. Date: Aug. 2, 2007

(54) DECORATIVE LIGHTING STRING

(76) Inventor: Ching-Tien Tsai, Er Lin Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/307,232

(22) Filed: Jan. 27, 2006

(51) Int. Cl. F21V 33/00

(52) U.S. Cl. 362/253

(57) ABSTRACT

A decorative lighting string, which comprises a connector, a rectifier, an housing, a LED lamp and a PCB circuit board. The PCB circuit board is defined with an IC controlling circuit that is provided for controlling the flashing frequency and brightness of the LED lamp, and the LED lamp is electrically connected to the output end of the IC controlling circuit, and the LED lamp and the PCB circuit board are defined in the housing. The flashing effects of the LED lamp can be changeable by using different kinds of wafers, and the connector is connected with an ordinary decorative lighting string directly or connected with the direct current via the rectifier for supplying power. Therefore, this invention is secure and easily assembling.

### BACKGROUND OF THE INVENTION

1. Field of the Invention

The present invention relates to a decorative light, and more particularly to an easily assembled decorative lighting string which allows easy connection and can create different flashing effects.

2. Description of the Prior Art

A decorative lighting string is usually installed on trees, in rooms or entertainment places for enhancing the festival atmosphere. A conventional decorative lighting string usually comprises a wire, one end of the wire is formed with a plug for connecting with the power source, and several branch lines having decorative lights thereof are parallel connected to the wire. An early decorative lighting string has no flash function, and its brightness is unchangeable, which is monotonous. Thereby an improved decorative lighting string is developed, which can flash. However, the branch lines are fixed to the wire, after assembly, the decorative lights cannot be replaced, therefore, the shape of the decorative light string is monotonous furthermore, the color of the lights is also monotonous.

The present invention has arisen to mitigate and/or obviate the afore-described disadvantages.

### SUMMARY OF THE INVENTION

The primary objective of the present invention is to provide a decorative lighting string which can change the flashing effects.

The decorative lighting string is comprises a connector, a rectifier, an housing, a LED lamp and a PCB circuit board. The PCB circuit board is defined with an IC controlling circuit that is provided for controlling the flashing frequency and brightness of the LED lamp, and the rectifier is disposed with a rectifying circuit, and the input and the output end of the rectifying circuit are connected with the input end of the connector and the IC controlling circuit via a wire respectively, and the LED lamp is connected with the output end of the IC controlling circuit, and the LED lamp and the PCB circuit board are defined in the housing.

The above-mentioned housing is cylinder-shaped and candle-shaped.

The above-mentioned input end is a device for direct current and alternating current.

The IC wafers are provided for controlling the glittering frequency and brightness of the LED lamp and connecting the different colors of LED lamps with each other so as to form multi-color lamps, and the connector is connected with an ordinary decorative lighting string directly or connected with the direct current via the rectifier for supplying power. Therefore, this invention is secure and easily assembling.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a is a perspective view of a decorative lighting string in accordance with the present invention;

FIG. 2 is a partial exploded view of the decorative lighting string in accordance with the present invention;

FIG. 3 is a perspective view of the decorative lighting string in accordance with another embodiment of the present invention;

FIG. 4 is a first circuit theory view of the decorative lighting string in accordance with the present invention;

FIG. 5 is a second circuit theory view of the decorative lighting string in accordance with the present invention;

FIG. 6 is a third circuit theory view of the decorative lighting string in accordance with the present invention; and

FIG. 7 is a perspective view of the decorative lighting string in accordance with a further embodiment of the present invention;

### DETAILED DESCRIPTION OF THE PREFERRED EMBODIMENTS

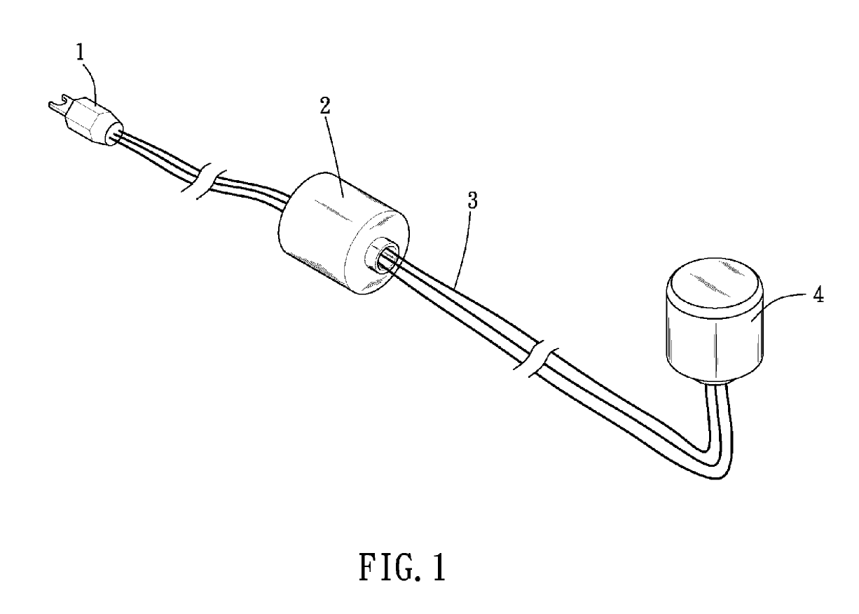

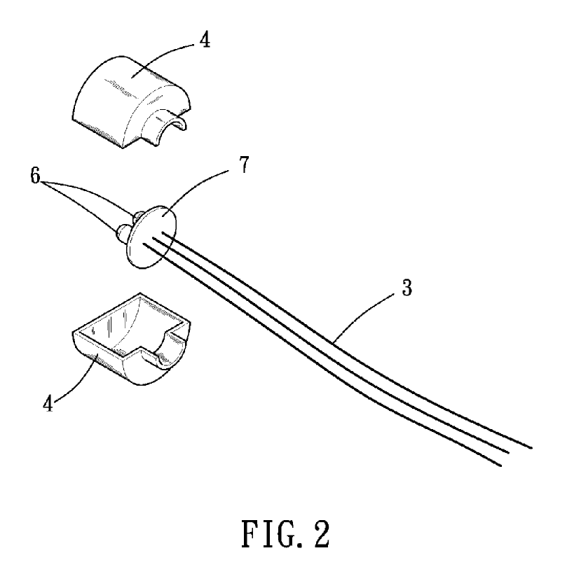

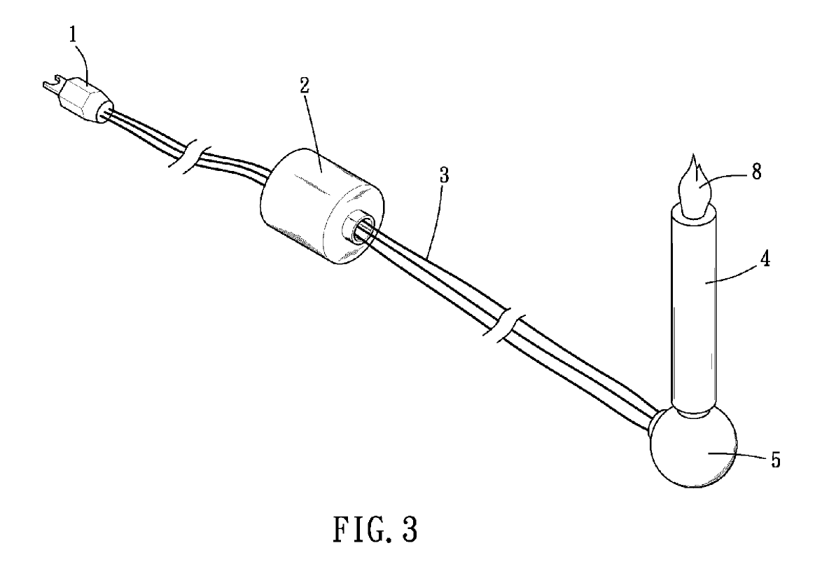

Referring to FIGS. 1-3, FIG. 1 is a perspective view of a decorative lighting string in accordance with the present invention, FIG. 2 is a partial exploded view of the decorative lighting string in accordance with the present invention, and FIG. 3 is a perspective view of the decorative lighting string in accordance with another embodiment of the present invention. A decorative lighting string comprises a connector 1, a rectifier 2, a housing 4, a LED lamp 6 and a PCB circuit board 7. The connector 1 is connected to an ordinary decorative lighting string directly or connected to the direct current via the rectifier 2 for supplying power. The housing 4 is cylinder-shaped, or candle-shaped or any shaped of the decorations.

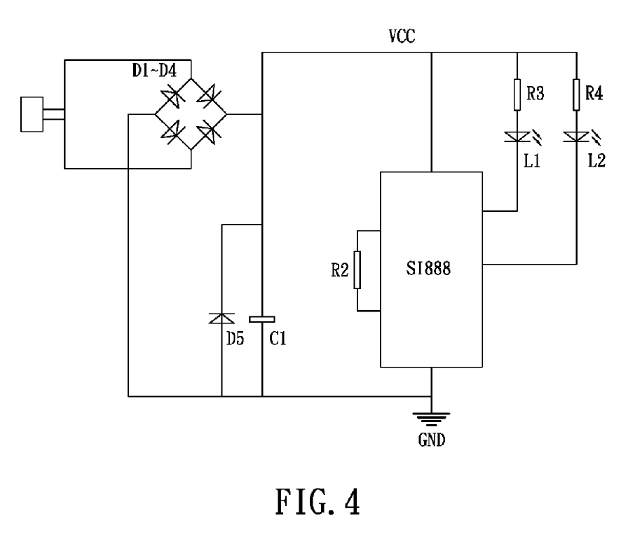

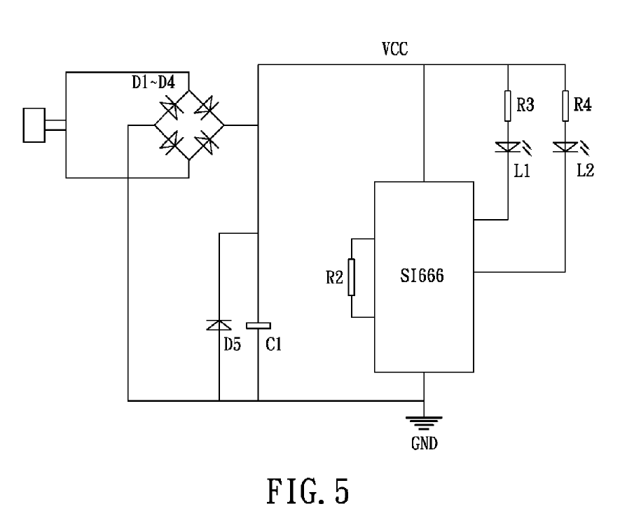

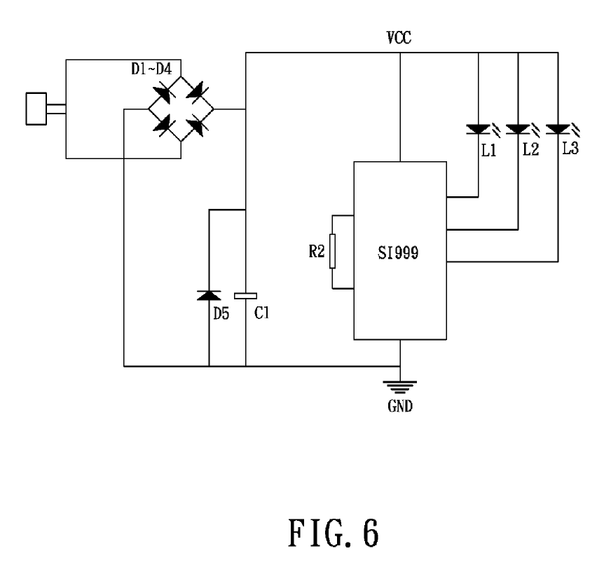

The PCB circuit board 7 is defined with an IC controlling circuit that is provided for controlling the flashing frequency and brightness of the LED lamp 6. The rectifier 2 is disposed with a rectifying circuit, the input and the output ends of the rectifying circuit are connected to the input end of the connector 1 and the IC controlling circuit via a wire 3 respectively, and the LED lamp 6 is connected to the output end of the IC controlling circuit as shown in FIGS. 4-6, when the decorative lighting string is turned on, the current is guided by the connector 1, then rectified by the bridge rectifier, and then stabled the voltage via D5 and filtered by C1, and supplying power to the IC wafer, and the IC wafer is provided for controlling the flashing frequency and brightness of the LED lamp 6, (4) thereby the flashing effects of the LED lamp 6 can be changeable by different kinds of wafers. R2 and IC form a vibrating circuit, and adjusting the resistance value of R2 can control the glittering frequency of the LED lamp 6.

The above-mentioned cylinder-shaped housing 4 as shown in FIG. 1 and 2, since the size of the housing 4 is very small, when the LED lamp 6 is welded to the PCB circuit board 7 and electrically connected with the output end of the IC controlling circuit, the PCB circuit board 7 is engaged in the housing 4.

The said housing 4 can be candle-shaped as shown in FIG. 3, the housing 4 is disassembled, which is connected with a base 5, and the PCB circuit board 7 is engaged in the base 5, the LED lamp 6 is electrically connected with the IC controlling circuit via the wire and formed on the top of the housing 4 viz. formed in the candle head. Since the housing 4 is made of transparent material, the lighting of the LED lamp 6 will be irradiated to the outer portion of the housing 4 through the housing 4.

The said IC controlling circuit, the flashing effects of the LED lamp 6 can be changeable by using different kinds of wafers. For example, using the wafer of type S1888, the LED lamp 6 will be flashed changeably, and using the wafer of type S1666, the brightness of the LED lamp 6 can be controlled, and using the wafer of type S1999, the LED lamp 6 will be flashed one by one orderly in turns.

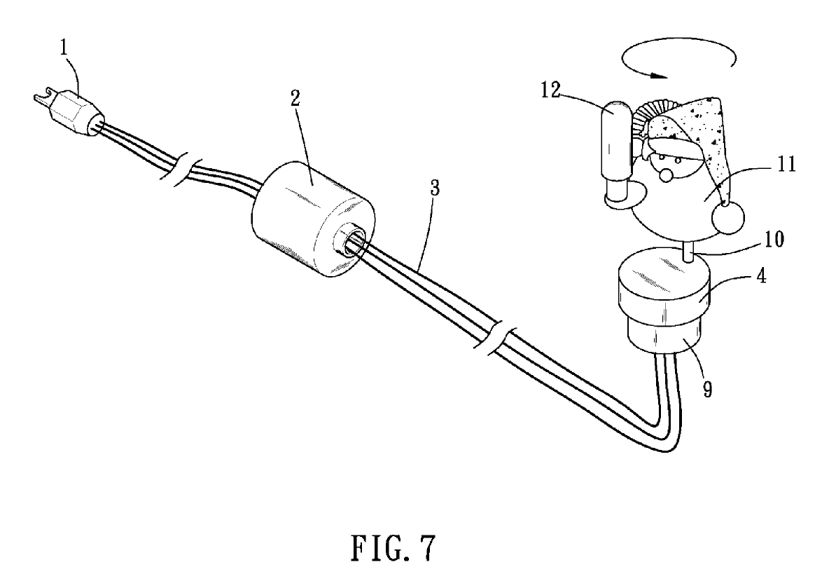

Referring to FIG. 7, a perspective view of another embodiment of the present invention, the lower part of the housing 4 is connected with a DC motor 9, and a decelerating gear assembly is defined in the housing 4 (not shown). The axle center of the DC motor 9 is inserted in the housing 4 so as to connect with the decelerating gear assembly, and the decelerating gear assembly is further connected with a revolution axis 10 and extended out of the top of the housing 4 as so to connect a decoration 11 with a LED lamp 12 thereof. By such arrangement, when using, the revolution axis 10 is rotated by the DC motor 9 via the decelerating gear assembly so as to rotate the decoration 11.

While we have shown and described various embodiments in accordance with the present invention, it should be clear to those skilled in the art that further embodiments may be made without departing from the scope of the present invention.

What is claimed is:

1. A decorative lighting string comprising a connector, a rectifier, an housing, a LED lamp and a PCB circuit board, wherein the PCB circuit board is defined with an IC controlling circuit that is provided for controlling the flashing frequency and brightness of the LED lamp, and the rectifier is disposed with a rectifying circuit, and the input and the output end of the rectifying circuit is connected to the input end of the connector and the IC controlling circuit via a wire respectively, and the LED lamp is connected to the output end of the IC controlling circuit, and the LED lamp and the PCB circuit board defining in the housing.

2. The decorative lighting string as claimed in claim 1, wherein the housing is cylinder-shaped and candle-shaped.

3. The decorative lighting string as claimed in claim 1, wherein the input end is a device for direct current and alternating current.

4. The decorative lighting string as claimed in claim 1, wherein a lower part of the housing connecting with a DC motor, and a decelerating gear assembly defining in the housing, and the axle center of the DC motor inserting in the housing so as to connect with the decelerating gear assembly, and the decelerating gear assembly is further connected with a revolution axis and extended out of the top of the housing as so to connect a decoration with a LED lamp thereof.
